(19) United States
(12) Patent Application Publication
(10) Pub. No.: US 2010/0332300 A1
(43) Pub. Date: Dec. 30, 2010

(54) INTERACTIVE NEIGHBORHOOD MODELER WITH RELATED ECONOMY AND GAME

(76) Inventor: JUNE SWATZELL, LIBERTY LAKE, WA (US)

Correspondence Address: Mark Farrell Patent Law, Inc., PC, P.O. Box 142056, Spokane, WA, 99214, US

(21) Appl. No.: 12/826,535

(22) Filed: Jun. 29, 2010

Related U.S. Application Data
(60) Provisional application No. 61/221,397, filed on Jun. 29, 2009.

(51) Int. Cl. G06Q 30/00; G06T 15/00; G06Q 10/00; G06F 17/30

(52) U.S. Cl. 705/14.7; 345/419; 705/348; 707/740; 707/E17.09; 707/769

(57) ABSTRACT

An interactive neighborhood modeler with related economy is described. In one implementation, a system creates an interactive 3-D analog of features in a geographical area delineated by zip code or other boundary, and visually renders the interactive analog with a degree of distortion suitable for accommodating the geographical area on a display. Each feature is assigned a data space, in which an authorized representative for each feature may custom edit information. Brick-and-mortar entities within the geographical area can be allotted a virtual storefront free of charge or by subscription. A user may interact with the 3-D analog to navigate a virtual neighborhood, shop, view multiple perspectives of features, and obtain the custom information associated with each feature provided by the authorized representative, including pictures, videos, and links for transacting business. The interactive modeler may post advertisements, and share revenue from advertisers among the brick-and-mortar entities that maintain a virtual storefront.

### BACKGROUND

There is a plethora of conventional web services that can be browsed to obtain a map of a given location. Such web services can typically generate a relevant map given an address as a starting point or if a user navigates to the correct location from a global map. The conventional map that is displayed is usually pan-able and zoom-able: the user can move the map from side-to-side and zoom in and out at different elevations from ground level to obtain various detail resolutions. At the resolution of an individual neighborhood, the conventional map shows good map detail, but is fairly impersonal and agnostic with respect to the actual character of the human community residing at that location, the local economy, and the many community and business interactions that define the neighborhood.

There are also websites that try to provide a great deal of information chamber-of-commerce-style about a given township. Such websites typically provide many statistics about the township and provide a search mechanism that applies one of the well-known all-Internet search engines to produce a prioritized list of textual search results about an aspect of the township.

Further, there are websites that function as online classified advertisements for a locality. Such websites are very similar to the classified advertisements of paper newspapers, posting ads bulletin-board style according to category.

These various tools and websites suggest a longstanding need for a system that truly models a living, moving community in great depth, faithfully capturing and reproducing the life functions and character of a neighborhood or locality. Such a system would provide a model of the neighborhood in miniature, and allow a user to conveniently tour the neighborhood and perform many of the interactions that the user might perform on a live walk or drive through the neighborhood.

### SUMMARY

An interactive neighborhood modeler with related economy and game is described. In one implementation, a system electronically creates an interactive 3-D cartoon analog of features in a geographical area delineated by a postal zip code, and visually renders the interactive analog with a degree of distortion suitable for accommodating the size of the geographical area. Features may include natural terrain and community infrastructure, such as streets, businesses, and schools. Each feature is assigned a data space, in which an authorized representative for each feature may custom edit information. Brick-and-mortar entities within the geographical area can be allotted a virtual storefront free of charge. A user may interact with the cartoon analog to navigate around a virtual neighborhood, shop, view multiple perspectives of features, and obtain the custom information associated with each feature provided by the authorized representative, including pictures, videos, and links for transacting business. The interactive modeler may post advertisements, and share revenue from advertisers among the brick-and-mortar entities that maintain a virtual storefront by contributing the custom information. The system may extend a game, e.g., for schools, in which students answer questions to learn about features in their neighborhood. Each correct answer earns a share of the advertising revenue for their classroom.

The interactive neighborhood modeler includes innovative features. The cartoonized interactive analog can dynamically change the amount of visual detail to highlight a feature, to decrease the learning curve for familiarizing the user with the depicted neighborhood, or to suit a particular age group. Thus, the interactive analog can be presented as a globemap that is more attractive and easier to learn than conventional maps. The globemap is interactive, allowing a user's display to analogize the local neighborhood in many ways. A perspectives engine allows the system to show multiple views of features, including interior views. A game engine invites schools and businesses to have fun learning about the local community and the A-to-Z products and services described by the customized information contributed by the brick-and-mortar participants. The game also allows players to earn points or revenue for their classroom or institution. Businesses can customize their virtual storefront, provided for free, and in doing so also earn revenue just by participating.

A search aggregation feature enables users to find instances of a type of store, business, or institution within the neighborhood. A sustainability feature estimates a sustainability score and provides product and service providers with information on how to achieve a more cohesively functional community.

This summary section is not intended to give a full description of the interactive neighborhood modeler, economy, and game, or to provide a comprehensive list of features and elements. A detailed description of example embodiments of the interactive neighborhood modeler follows.

### BRIEF DESCRIPTION OF THE DRAWINGS

FIG. 1 is a diagram of an exemplary kiosk embodiment of a neighborhood modeling system.

FIG. 2 is a block diagram of a distributed implementation of an exemplary neighborhood modeling system.

FIG. 3 is a block diagram of the exemplary neighborhood modeling engine of FIGS. 1 and 2, in greater detail.

FIG. 4 is a screenshot diagram of the exemplary user interface of FIGS. 1 and 2, in greater detail.

FIG. 5 is a flow diagram of an exemplary method of creating an interactive analog of a neighborhood.

FIG. 6 is a flow diagram of an exemplary method of coding and classifying features to create an interactive analog of a neighborhood.

FIG. 7 is a flow diagram of an exemplary game method for familiarizing a user with features of a neighborhood and offering a monetary reward for successful game play.

FIG. 8 is a flow diagram of an exemplary economic method of collecting and distributing revenue associated with modeling a neighborhood.

FIG. 9 is a flow diagram of an exemplary method of searching for similar features within a modeled neighborhood.

### DETAILED DESCRIPTION

### Overview

This disclosure describes an interactive neighborhood modeler, with associated economy and game. Each of these components can be considered separately and even used separately, but together or in a combination, these components may form a system that transforms a user's display into an analog of the user's neighborhood. “Analog,” as used herein, means a live model or working model that recreates the neighborhood in miniature, so that interactions often have the same practical and legal efficacy as real-world interactions carried out by the user, e.g., at brick-and-mortar businesses. A “neighborhood” is typically a locality in familiar proximity to a given user, and for purposes of this description will be exemplified by a locality as delineated by a postal zip code.

In one implementation, an exemplary neighborhood modeler is composed of electronic hardware within a kiosk to be made public in a community place. The kiosk allows passers-by to consult an interactive electronic analog of the current locality and retrieve customized information for each community feature in the neighborhood, communicate directly with representatives of some features, and to shop and transact business via the electronic analog. The information provided for each community feature is editable in real time by a representative for each feature, acting remotely.

In one implementation, the electronic analog may be similar to a map, cast as a 3-D sketch, cartoon, or caricature (hereinafter “cartoonized analog”) of the locality. The cartoonized analog can display all or can display a limited number of the terrain features and community features in the neighborhood in order to meet a visual simplicity threshold. That is, a number of the features may be visually reduced to present a non-threatening graphic that is easy and pleasant for a newcomer to view and navigate. Such a cartoonized analog thus meeting the pre-selected visual simplicity threshold accelerates familiarity and decreases the learning curve for knowing and navigating the local neighborhood being modeled. The visual simplicity threshold can be selected for different age groups and sophistication levels to provide a visually elementary analog of the neighborhood for some users while providing a visually detailed analog for very serious users. Also, the displayed features can be staged from an elementary disposition to a detailed disposition over a time interval in order to quickly orient a user to the location of a particular feature and then its context in the neighborhood.

The features displayed may include different feature types, including physical features, infrastructure features, and community features of the locality. For example, the features may include geographical features (e.g., hills, trees, lakes, rivers, natural landmarks, terrain, landscape formations); streets, parks, and utility routes; stores and business entities, and other community features of the geographical area. The community features may include, for example, businesses, schools, churches, government organizations, travel routes, building structures, historical locations, and the toponyms (place names) that label these features.

The features to be displayed on the interactive analog may also include moving features with locations updatable in real time. For example, the interactive analog may show locations of emergency vehicles, traffic problems, weather features, community events, news events, sales, and advertisements with dynamic locations updated in real or near real time, to realistically depict a current state of the actual neighborhood.

In one implementation, the interactive neighborhood modeler can provide the framework for an exemplary web service designed to offer a locality's residents and visitors a full range of opportunities for active community living. For example, brick-and-mortar businesses, organizations, schools, etc., can have a virtual storefront or home front in the exemplary web service, as powered by the neighborhood modeler, and can participate in local and global economies, e.g., via contributing at least classified ads; and can benefit from revenues generated by paid ads placed by other entities on the web service.

To implement such a web service, the neighborhood modeler may execute various functions, such as selecting a geographical area delineated by a postal zip code or by manual input and creating a 2-dimensional (2-D) globemap of the geographical area—in which the 2-D globemap visually represents a 3-dimensional (3-D) cartoon analog of the features within the locality. The 2-D globemap may be visually rendered on a part of a surface of a virtual sphere, thus forming a “globemap.” The globemap may apply a fish-eye perspective, in which features closer to the center of the globemap appear somewhat closer to the viewer than those near the outer circumference of the virtual sphere. Of course, other shapes and presentation paradigms map be used to display the cartoon analog of the neighborhood. More fish-eye perspective may be used for larger neighborhoods to accommodate the depiction of more geographical area near the edges of the globemap.

Each type of feature within the geographical area may be coded with a corresponding cartoon attribute in the 3-D cartoon analog to create categories of cartoonized features. The neighborhood modeler may further associate an information data space with each cartoonized feature, and then authenticate representatives who each have some credential for representing or “speaking for” their respective feature: e.g., as an owner of a business. Each entity representing an actual feature in the neighborhood—i.e., a representative of a home or business that registers with the web service in order to present custom information related to their corresponding feature on the web service—also becomes a stakeholder in a related economic model to be presented below. In one scenario, registration is free of charge. The neighborhood modeler receives customizations, edits, and other information about a respective feature from the representative, to store in the information data space associated with the respective feature.

When implemented as a web service, the neighborhood modeler displays a part of the 2-D globemap including the associated cartoonized features, on a user interface. The number of the cartoonized features included in the displayed part of the 2-D globemap varies to meet a visual simplicity threshold. The customized information associated with a cartoonized feature can be individually accessible by navigating to the cartoonized feature on the user interface, as will be described in greater detail further below.

As introduced above, the exemplary neighborhood modeler transforms a user's display screen into a working analog of their local neighborhood. Neighborhoods can appear as charming 3-D cartoon villages composed of businesses, institutions, houses, streets, lakes, mountains, etc. Specific types of businesses have the same look and can be similarly color-coded. A user can browse the displayed neighborhood via user interfaces, such as a computer display and mouse, acquire information placed each by each respective representative of a feature, stop in each virtual place and look around, conduct business, or enter into dialogue in real time with online users associated with each feature, and enter into many other forms of interaction.

The exemplary neighborhood modeler can also build a more cohesively functional community, as the exemplary web service can bring the stakeholders to a website to educate them about the community, provide or acquire goods, services, or information. The neighborhood modeler can provide a set of tools specifically designed to address key everyday aspects of living in the most simple and user-friendly manner, while providing free marketing space for classified ad, business, and community listings. In one implementation, the neighborhood modeler applies an active sustainability model, to support communities wishing to have prosperous longevity.

Exemplary Systems

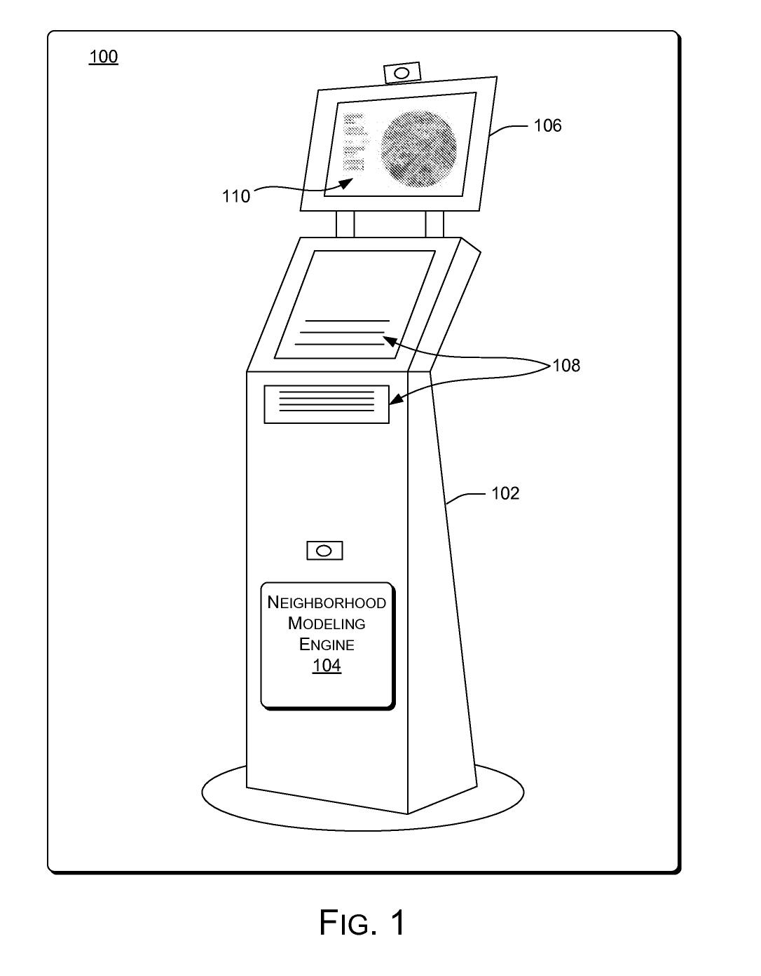

FIG. 1 shows an exemplary neighborhood modeling system 100 in a kiosk embodiment. The kiosk 102 hosts a neighborhood modeling engine 104, a display 106, and at least one user interface 108 for user input and interaction with the neighborhood modeling engine 104. The neighborhood modeling engine 104 may be executed as electronics in the kiosk 102.

The kiosk 102 can be located in a public place to allow passers-by to consult an interactive electronic analog of the current locality via a user interface 110, including retrieving self-customized information for each community feature in the neighborhood, communicating directly with representatives of some of the features, virtually touring the neighborhood to sight-see, and shopping and transacting business via the interactive electronic analog. The information provided for each community feature is editable in real time by an authorized representative of each feature, acting remotely or acting locally by installing information directly at the kiosk 102.

As introduced above, an interactive electronic analog is like a map, and may include map-like aspects and elements, but unlike a static map the analog has dynamically changing features that can be updated in real time, varying 3-D perspectives of analog features, and opportunities for user interaction associated with the visual features in the interactive analog. In other words, the neighborhood modeling engine 104 transforms a user's display 106 into the user's neighborhood—not just into a map of the neighborhood.

The interactive electronic analog provides various ways for a user to interact with the neighborhood or community being modeled, e.g., by providing a direct communication mechanism with multiple brick-and-mortar entities without leaving the user interface 110; shopping mechanisms, user-touring schemas with multiple 3-D visual perspectives of features in the neighborhood, virtual transportation with a capability to virtually go inside structures on the analog, real time event, news, and weather depiction and updating; news located at the site of the news occurrence, real time advertising of sales and specials as they happen, real time bingo, real time fundraising with real time display of cumulate percentage of goal achieved, real time auctions, etc. A user can take a virtual stroll and gather community information via the interactive analog. Importantly, each brick-and-mortar business or other interested entity in the neighborhood is allotted free storefront or homestead on the interactive analog of the neighborhood modeling system 100. For example, in one implementation, the interactive analog 330 is capable of showing a lemonade stand on a street corner that is present one day and gone the next day, as well as a depiction of the rain storm that caused it to close.

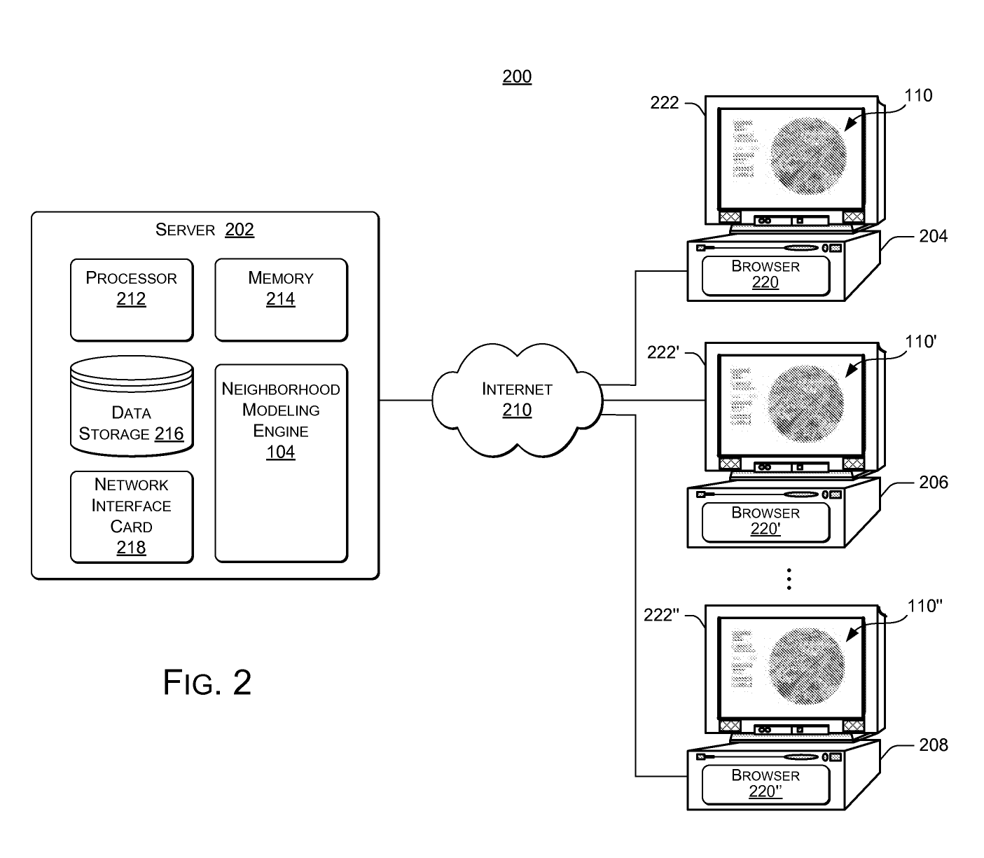

FIG. 2 shows another exemplary neighborhood modeling system 200. The second exemplary neighborhood modeling system 200 includes at least one server device 202 (“server”) and client devices, such as client “one” 204, client “two” 206, . . . , client “N” 208 communicatively coupled with a network, such as the Internet 210 as shown. Each typical server 202 includes a processor 212, memory 214, data storage 216, a network interface 218, and an instance of the neighborhood modeling engine 104. The neighborhood modeling engine 104 may consist of electronic hardware, such as application specific integrated circuits (ASIC chips) or combinations of hardware and software.

Each client 204, 206, 208 includes a browser 220 for accessing web services via the Internet 210. The neighborhood modeling engine 104 extends a user interface (UI) 110 on each client display 222 for the respective user to access services of the neighborhood modeling engine 104, e.g., via a website hosted by the server 202.

The exemplary neighborhood modeling system 200 of FIG. 2 enables a community to access their neighborhood virtually through a widely available Internet connections. In a typical scenario, a user designates the local postal zip code or other designator of a neighborhood boundary on the user interface 110 displayed on a client device 204 to specify the user's locality. The user can then access the interactive analog representing the neighborhood, as extended by the neighborhood modeling engine 104. If the user has standing to represent a brick-and-mortar feature within the designated neighborhood, then the user can register to be a representative of the feature and can then log in to a user account and access free virtual storefront space for the feature in the interactive analog of the neighborhood.

Exemplary Modeler

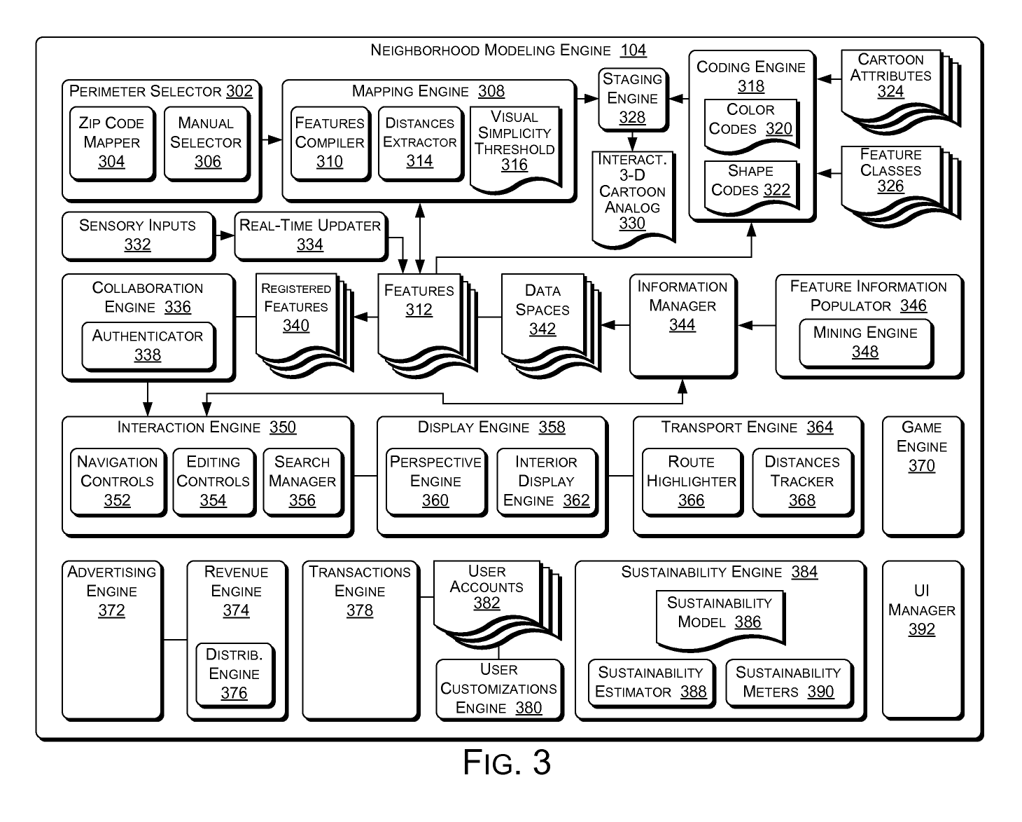

FIG. 3 shows the neighborhood modeling engine 104 of FIGS. 1 and 2 in greater detail. The illustrated implementation is one example configuration, for descriptive purposes. Many other arrangements of the components of an exemplary neighborhood modeling engine 104 are possible within the scope of the subject matter. Such an exemplary neighborhood modeling engine 104 can be implemented in hardware, or in combinations of hardware and software. Some communicative connections between the illustrated components are shown by line connections and arrowed lines. These lines and arrows are shown to facilitate the description, but do not represent the entire set of connections and communicative couplings within the neighborhood modeling engine 104. It should be assumed that every component has communicative access to every other component, since they are in the same engine.

The illustrated neighborhood modeling engine 104 of FIG. 3 includes a variety of components. A perimeter selector 302 includes a zip code mapper 304 and a manual (perimeter) selector 306. A mapping engine 308 includes a features compiler 310 for determining the features 312 to map into an analog of the neighborhood, a distances extractor 314, and a buffer for storing a visual simplicity threshold value 316. A coding engine 318 includes color-codes 320 and shape codes 322 for assigning cartoon attributes 324 and feature classes 326 to features 312 to be mapped.

The mapping engine 308 and the coding engine 318 may be coupled with a staging engine 328 that outputs the dynamic 3-D cartoon analog 330 (“interactive analog” 330) of the neighborhood. It should be noted that the features 312 to be incorporated into the 3-D cartoon analog 330 are not static map components, but are associated with respective data spaces, with information editable in real time and with pointers and links to functions, such as visual perspective functions and monetary transaction functions. The features 312 themselves, may be updated in real time or near real time, e.g., as when the feature is a moving emergency vehicle or news event. Sensory inputs 332 receive input criteria for modifying the nature or the location of a feature 312 and signal a real-time updater 334 to modify the feature 312.

A collaboration engine 336 includes an authenticator 338 to register and authorize a human representative of a feature 312 so that the representative can add or edit information about a feature 312. The resulting registered features 340 can be used in an economic model of revenue sharing, below.

Each feature 312, whether a geographical landmark or a business, can have an associated data space 342 for presenting associated information via the interactive analog 330. An information manager 344 administrates the information in the data spaces 342. A feature information populator 346 may initially apply a mining engine 348 to fill the data spaces 342 associated with the features 312 with nominal information about the features that is already available, e.g., via the Internet 210.

An interaction engine 350 includes navigation controls 352 for interpreting navigation input from users, editing controls 354 for allowing the representatives to edit information for the registered features 340, and a search manager 356. The search manager 356 can implement a user's search for a feature 312, or for a group of features 312 within a feature class 326, by designating an icon of other visual depiction of one feature 312 to return the other features 312 of that feature class 326 within the neighborhood. The search manager 356 can also find features 312 via a keyword search or criterion search.

A display engine 358 includes a perspective engine 360 for showing different views of a feature 312 and an interior display engine 362 to reveal interior views of a feature 312. A transport engine 364 includes a route highlighter 366 to track a user's navigation around the interactive analog 330, and a distances tracker 368 to return real-world distances as navigated on the interactive analog 330.

A game engine 370 leverages the neighborhood modeling engine 104 to provide both an education about the neighborhood and its many features 312, and a revenue-making mechanism for schools and other organizations.

An advertising engine 372 manages advertisements that can be displayed as banner ads on the interactive analog 330. The banner ads can provide revenue for an economic model used with the neighborhood modeling engine 104. In one scenario, a revenue engine 374 includes a distribution engine 376 to share at least part of the revenue with the registered features 340.

A transactions engine 378 allows a user to perform a purchase, sale, or other monetary transaction directly through the neighborhood modeling engine 104. A user customizations engine 380 creates and accesses user accounts 382, and stores user preferences as to the appearance of the interactive analog 330, favorite places and routes through the neighborhood, etc.

A sustainability engine 384 applies a sustainability model 386 to the designated neighborhood and its features 312. Thus, a sustainability estimator 388 applies sustainability criteria to obtain a sustainability estimate or score, which can be displayed by sustainability meters 390.

A user interface manager 392 extends the user interface 110 to client devices (e.g., 204) or to the display 106 on a kiosk 102. Server 202 and/or networking software may also provide user interface and web page management automatically for the neighborhood modeling system 200.

In one implementation, a neighborhood modeling system 200 includes a neighborhood modeler 104 for creating an interactive analog 330 of a geographical locality defined by a selectable boundary, wherein the geographical locality includes a dynamic number of features 312, a sensor input 332 to receive updates about the statuses of the features 312, a real time updater 334 to display the interactive analog 330 on a user interface 110, including a current state of each feature 312 of the geographic locality to be displayed; an information manager 344 to: associate data with each feature, authenticate a respective representative for each feature 312, and receive edits from the representatives to update the data during a runtime of the interactive analog 330. The neighborhood modeling system 200 also includes an interaction engine 350 to receive navigation signals from a user via the user interface 110. When the user selects one of the features 312 the currently updated data associated with the feature 312 is displayed.

The neighborhood modeling system 200 further includes: a transactions engine 378 to enable monetary transactions between the user and the authenticated respective representative of a feature 312 via an Internet link provided in the data associated with the feature 312. A perspective engine 360 enables the user interface 110 to display different views of a feature 312, from different perspectives, including at least one interior view of the feature 312. A transport engine 364 tracks a navigation route of the user through the geographical locality represented by the interactive analog 330 and may return analogous real-world distances that correspond to parts of the navigation route of the user.

The data associated with a feature 312 enables the user to shop for goods and services via the feature 312 on the interactive analog 330. The data associated with a feature 312 can include store information or a classified advertisement. The neighborhood modeler 104 can also enable the user to communicate in real time with a representative of a feature 312 via the interactive analog 330.

In such an implementation, it should be noted as above, that the features 312 can include geographical features including hills, trees, lakes, rivers, natural landmarks, terrain, landscape formations, buildings, streets, parks, travel routes, utility routes, stores, homes, schools, businesses, churches, government organizations, historical locations, and associated toponyms of the features.

The features 312 may also include vehicles and construction sites, including an emergency vehicle with a location displayed on the interactive analog in real time or near real time. The features 312 may include weather features displayed on the interactive analog 330 in a location corresponding to a location of the weather in the real-world and with changes in the location of a weather feature displayed on the interactive analog 330 in real time or near real time.

The features 312 may further include traffic events, community events, and news events, which may be represented by a corresponding cartoon feature on the interactive analog 330 with a dynamic location updated in real time or near real time.

An alert may be displayed on the interactive analog 330 when an edit in the data associated with a feature is received by the neighborhood modeler 104, and the alert may show the location of the feature 312 associated with the edit, or the edit itself.

The selectable boundary defining the geographical area may include a boundary defined by a postal zip code or a boundary defined by manual selection of a geographical area by the user.

The neighborhood modeler 104 displays a variable number of the features 312 in the interactive analog 330 according to a visual simplicity threshold 316. The neighborhood modeler 104 may perform a staged display of the features 312 on the interactive analog over a time interval, from relatively few features displayed at the beginning of the time interval to relatively many features displayed at the end of the time interval. The staged display can orient the user to a particular feature 312 by presenting an elementary depiction of the geographical locality and then providing detailed visual context of the particular feature.

Components of the neighborhood modeling engine 104 may use software instructions. Thus, a machine-readable storage medium may include instructions, which when executed, cause hardware components of a machine to execute steps, that include creating a cartoonized analog of a community bounded by the borders of a postal zip code, linking each community feature portrayed in the cartoonized analog with a data space, projecting a user interface on a display, including an interactive form of at least part of the cartoonized analog, extending editing controls to a registered representative of a community feature to modify information in the respective data space associated with the community feature, receiving input from a public user interacting with the cartoonized analog, the input designating one of the community features, and displaying the information to the public user.

Example User Interface for Viewing and Navigating

The interaction engine 350 provides navigation controls for moving around the virtual reality of the interactive analog 330. The cartoonized attributes of the displayed features 312 attract and facilitate the user's familiarization with reality. The 3-D cartoon analog 330 provides cartoon graphics of businesses, buildings, roads, etc., as well as map structure that is distorted enough to accommodate the cartoon graphics. It is easy for the user viewing and interacting with the 3-D cartoon analog 330 to make the mental transition to the real world, in that all of the cartoonized structures, (buildings, roads, terrain) can be of similar appearance as in the real world, albeit cartoon renditions, and because the interactive 3-D cartoon analog 330 can be visually simplified to quickly orient the user to features of the neighborhood and to present a nonthreatening amount of detail, at least at first.

When the neighborhood modeling system 200 is implemented over the Internet 210, as in FIG. 2, then the neighborhood modeling engine 104 underlies a web service accessible via the Internet 210, and the user interface 110 is made up of a hierarchy of linked web pages constituting a website.

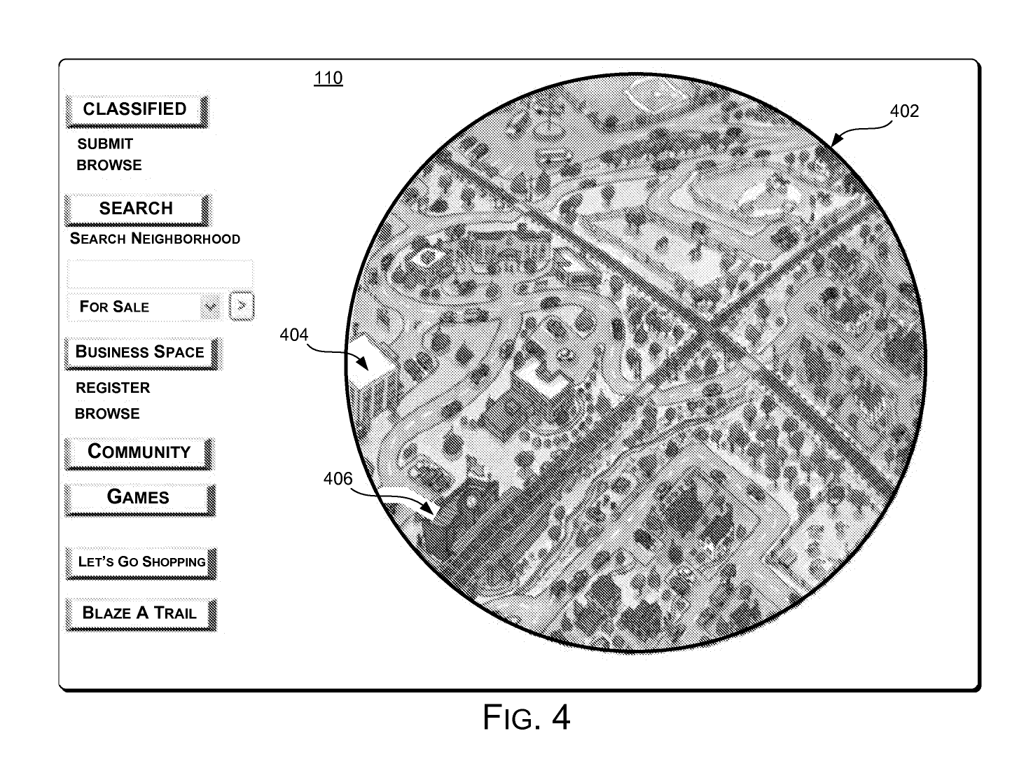

FIG. 4 shows an example implementation of the user interface 110 of FIGS. 1 and 2, in greater detail. When the neighborhood modeling system 200 is implemented via the Internet 210, then the user interface 110 shown in FIG. 4 may constitute a home page of a website associated with the web service.

In one implementation, the interactive 3-D cartoon analog 330 constitutes a “globemap” 402 in which at least part of the interactive analog 330 is displayed on each user interface 110 as appearing on the surface of a disk or as if on a virtual sphere. A degree of fish-eye perspective may be applied to emphasize objects closer to the center of the virtual sphere by increasing their size. Alternatively, the perspective engine 360 may “roll the perspective” of the globemap 402 so that, for example, the viewer appears to be directly overhead objects near the bottom of the globemap 402, while objects near the top of the globemap 402 are afforded an increased elevation view and increased 3-D perspective, in which more of the sides of objects are visible to the viewer.

Thus, in one implementation, the interactive analog 330 appears to be “mapped on a sphere” and as a user mouses-over various features 312, each feature 312 may “pop up” into a larger size or different object and reveal a logo and/or an “icon” (e.g., in cartoon rendering) of the business, or facility, as well as part or all of the information in the corresponding data space 342. The user may click on any part of the globemap 402 and drag the displayed part of the interactive analog 330 in any direction across the virtual sphere, moving the interactive analog 330 horizontally, vertically, or diagonally.

In one implementation, the larger the neighborhood, the more fish-eye perspective is applied so that the edges of the globemap 402, where the objects are smaller than in the center, may accommodate larger geographical areas. A 3-D spherical appearance of the globemap 402 can be applied as an intentional illusion, because in actuality the interactive analog 330 is displayed on flat display, but as an object is moved closer to the center of the virtual sphere the object becomes larger, giving the perception of being mapped on a visually spherical surface.

When a user arrives at a boundary of the neighborhood, the adjacent neighborhood may be identified, but in one implementation the user cannot navigate into the new neighborhood without specifying its identity, e.g., via a new postal zip code or other delineator.

The distances between features 312, for example, between feature 404 and feature 406, may be displayed with some license to accommodate the cartoonized features 312, or even intentionally distorted for caricature and therefore not actual 1:1 correspondences between real objects as on a literal map. The depicted buildings and roads may be out of scale to the actual dimensions and distances of the buildings and roads in the actual neighborhood.

This intentional distortion of sizes and distances in the 3-D cartoon analog 330 provide a desirable caricature that can be exploited to emphasize a desired feature, e.g., a search result. However, the distances extractor 314 stores the actual dimensions of structures, lengths of roads, and relative orientation of features 312 with respect to each other, so that real distances can displayed at will, or the 3-D cartoon analog 330 can be modified as needed to show an accurate depiction of sizes and distances. For example, the neighborhood modeling engine 104 may offer toggling between a first mode in which the cartoon distances are a caricature of the actual distances, and a second mode in which the actual distances are accurately scaled.

Dynamic Search Features

The search manager 356 can perform searches for information already in the possession of the neighborhood modeling engine 104, for example, the features 312 themselves and information in the data spaces 342 associated with the features 312, information in the user accounts 382, the registered features, and so forth. In one implementation, the search manager 356 can find information about the community within a local zip code, regional area, or town using a search engine on the larger Internet 210.

The search manager 356 may aggregate every instance of a certain feature class 326 into a graphical search result. For example, the search manager 356 may find each instance of a certain type of business and display these as a cartoon group that constitutes a graphical marketplace. In one implementation, the user interface 110 has a “Let's Go Shopping” button or icon. If a user is searching for fresh produce grown locally, for example, the user might key this information into a text box field and click the “Let's Go Shopping” button. In one implementation, the display engine 358 presents a 3-D set of cartoonized shop icons representing the search result: the businesses that deal in fresh produce. The search manager 356 can display the search results in a group, so that the user can explore the different shops quickly—for example, the user can browse with a mouse through the shops, that are lined up as icons along a street; navigate over the shops, or enter the shops via the interior display engine 362 to view what each has to offer and how to acquire their products. Alternatively, the search manager 356 can highlight each individual search result in situ, in each respective location of a produce business on the interactive analog 330. In the search results, all local providers of fresh produce are represented; large businesses, small businesses, as well as local fresh produce farmers, unless the search criteria specify the size of the business or organization.

The search manager 356 can also present the search results on the interactive analog 330 of the neighborhood with all features removed except the search result features, or with some features removed in order to highlight the search result features. A mouseover or selection of a feature 312 may yield or pop-up the current sales and store information of the feature 312, such as its purpose, location, and hours of operation.

Touring, Transporting, and Traversal

Whereas navigation entails moving a mouse arrow or cursor around the interactive analog 330, the transport engine 364 also enables a user to move along portrayed streets via navigation of a marker or icon representing the user and receive information and distances via the distances tracker 368 at each intersection or waypoint. This can easily be accomplished by the user dragging an icon or marker of the user along the street with a “click and drag” movement of the mouse or pointing device. The user can also place flags at any location and derive distances between the locations. The route highlighter 366 enables the user to “blaze a trail” (light up a path) between the locations. In one implementation, the transport engine 364 interfaces with known mapping services which interact with the transport engine 364 to provide driving directions or a street view.

A user may drive or walk through the neighborhood displayed on the interactive analog 330. The user inputs an intersection in a “navigation window” and the intersection is moved to the center of the globemap 402. To move down a street, the user may simply click on a street and drag a marker of the user down the street, (at first, only main streets may be shown). In one implementation, the streets are “magnetized” so the user's marker stays on the street and when the user arrives at an intersection, the intersection may be identified via a popup information pane. The user may re-click, hold and drag the marker down any intersecting street desired. The user can reverse directions by making a U-turn and going back in the direction of arrival. In one implementation, the user may stop moving down a street anytime by releasing the mouse button or other pointing device and mouseover (fly) over other areas of the interactive analog 330. The display engine 358 may also roll the globemap 402 in relation to the navigation at a controlled speed, so that a current location of the user's marker in the neighborhood is constantly bringing that part of the neighborhood to the center of the virtual sphere.

As mentioned above, at each intersection a flag or information pane may popup with distance information, e.g., distance from the city center or other landmark. Thus, the user may right click a mouse, for instance, or doubleclick at any intersection to see how far the user is from the landmark. Along each street the route is populated with cartoonized houses, businesses, schools, etc. At least all active objects or registered features 312 identify themselves if the user mouses-over or otherwise selects them. The user may select or designate a cartoonized feature 312 to popup an information screen that contains the information customized by a representative of the feature 312, including profile information, location, phone number, web address, links to a home page, nature of the facility or business, pictures, videos, sounds, sales, hours of business, schedules, dates, what role the feature 312 plays in a sustaining the neighborhood, and so forth. In one implementation, a logo for the feature 312 appears first and provides a link to the data space 342, i.e., the business space or virtual storefront of the feature 312.

The route highlighter 366 enables the user to plant flags or anchor points to blaze a trail between locations. This is useful for mapping how to get to a desired location. The transport engine 364 may enable the user to print directions from one flag to another. In one implementation, the houses in neighborhoods between mapped streets are represented by blocks of cartoon houses. A user may blaze a trail from a specific feature 312 or structure in the block to a planted flag by double-clicking the block to reveal a text input box, and then entering an address of the particular feature 312 in the block. A “Blaze a Trail” button on the user interface 110 provides directions from the addressed feature 312 to the flagged location.

The staging engine 328 may enable the user to explore a neighborhood in steps. In one scenario, the perimeter selector 302 first inputs a user's choice of boundary, such as a postal zip code. The interactive analog 330 than displays a boundary map of the zip code area in cartoon, and gives the user an option of populating the boundary map, e.g., in a sequence, with terrain, main roads, infrastructure, businesses, schools, churches, etc., that become overlays or layers that can be added or removed by a click.

Neighborhood-Based Game

The game engine 370 can interface directly with the local schools in a neighborhood. The game engine 370 enables students and others an opportunity to learn about their neighborhood and many features 312 of the neighborhood while playing a game. For example, a student may learn of businesses, government features, parks, transportation, local history, etc. In one implementation, the games provided by the game engine 370 are specifically designed to coordinate with the educational goals of K-12 grade students. For example, it is usually deemed important for K-3 grade students to become socialized and know about their neighborhoods and communities.

Learning where a student lives, and becoming familiar with where their location is in relationship to business and industrial areas, stores, streets, parks, lakes, mountains, etc., is an important goal of early childhood education. Such familiarization with a young student's environment provides increased safety for the student and is fun. A beginning set of games directed to this age group teach these concepts and in one implementation provide an opportunity for the student to make money for their classroom. In one game, questions about the local neighborhood are posed. A correct answer to a question about the local neighborhood drops a token into a “piggy bank” for the student's classroom. A token may be worth a percentage of a cent, for instance. The value for the token comes from ad revenue from advertisements posted on the interactive analog 330. Separately, ad revenues garnered by the revenue engine 374 may be shared by the distribution engine 376 with each educational institution whose students and/or faculty incorporate a game, e.g., a “Know Your Zip” game provided by the game engine 370, into their curriculum.

The “piggy bank” or bank balance feature coordinates directly with a “Know Your Zip” game. During the course of a game a student (who is registered with his/her classroom) is asked questions directly related to important information outlined in the class curriculum. In one implementation, when a student gets a right answer to a question, coins (tokens), drop with an appealing sound into a piggy bank graphic or animation, and a running balance appears so that the student knows how much value they are making for their classroom. All the monies are totaled periodically and distributed to the classroom, e.g., via the teachers.

In another game, students are posed with a scavenger hunt to find features 312, or information about features, in their neighborhood. Finding a scavenger hunt item, or finding all items, earns a token or monetary revenue for the classroom.

An exemplary game method includes modeling a geographic region, creating a cartoon analog from the model categorizing community features of the geographic region, associating a respective data space with each community feature, extending an editing interface via a computer network for each representative of one of the community features, the editing interface to add and edit information in the respective data space of the community feature; and displaying the analog to a student in a school within the geographic region. Upon receiving input from the student designating one of the community features, the method includes displaying a question to the student concerning the community feature or concerning the information stored in the data space associated with the community feature; and upon receiving a correct answer to the question from the student, crediting a value unit to the school.

The value unit can be an amount of money, and the money constitutes revenue from an entity placing an advertisement displayed with the map to the student. In one scenario, a correct answer of a current question draws a subsequent question of greater difficulty than the current question, and an incorrect answer of the current question draws a subsequent question of lesser difficulty than the current question.

In a scavenger hunt variation, the game method includes compiling a sample of the community features, and requesting the student to locate on the interactive analog a sequence of the community features in the sample. When the student correctly locates a requested community feature, a value unit is credited to the school.

Related Economy

In one implementation, the neighborhood modeling engine 104 allots a data space 342 dubbed a “business space” or virtual storefront to every brick-and-mortar business (cottage industry to multi-nationals) or institution in the neighborhood. That is, each real-world business based in the neighborhood can register via the collaboration engine 336 to be a content provider that can be verified by the authenticator 338, fill their data space 342 with their own information, and self-edit the information through the editing controls 354. In one scenario, the interaction engine 350 provides a business information template, thus facilitating every business and institution in the neighborhood contributing free of charge.

In one implementation, the advertising engine 372 adds banner ads to the user interface 110, from paying advertisers. The banner ads are sponsored by paying advertisers. This produces some revenue for the neighborhood modeling system 100, 200. The revenue engine 374 shares the revenue from the banner ads with the various content providers for the interactive analog 330, i.e., the registered features 340. Thus, to increase content relevancy and community vitality the neighborhood modeling engine 104 shares ad revenue with all registered business owners who enter and maintain information in the data spaces 342 associated with the features 312.

The advertising engine 372 may emphasize a banner ad by attaching another desirable function to the displayed advertisement. For example, clicking on a banner ad may produce a weather report unrelated to the banner ad, or a news flash, or provide some other service for free that is not necessarily related to the content of the banner advertisement. In this manner, the advertising engine 372 can add value for an advertiser.

Sustainability Meters

The concept of sustainability embodies stewardship, design with nature, and carrying capacity, a highly developed modeling technique used by scientists and planners. The most popular definition of sustainability defines sustainable developments as those that “meet present needs without compromising the ability of future generations to meet their needs” (WECD, 1987). This well-established definition sets an ideal premise, but does not clarify specific human and environmental parameters for modeling and measuring sustainable developments. The following definitions are more specific: “Sustainable means using methods, systems and materials that won't deplete resources or harm natural cycles” (Rosenbaum, 1993). Sustainability “identifies a concept and attitude in development that looks at a site's natural land, water, and energy resources as integral aspects of the development” (Vieira, 1993). “Sustainability integrates natural systems with human patterns and celebrates continuity, uniqueness and placemaking” (Early, 1993). “Sustainable developments are those which fulfill present and future needs (WECD, 1987) while [only] using and not harming renewable resources and unique human-environmental systems of a site: [air], water, land, energy, and human ecology and/or those of other [off-site] sustainable systems” (Rosenbaum 1993 and Vieria 1993).

The sustainability engine 384 maintains a sustainability model 386 and applies the sustainability estimator 388 to determine a sustainability value for the neighborhood. The sustainability estimator 388 assesses the neighborhood's ability to provide food, shelter, clothing, etc. into the future, and graphically shows how the community scores at the current time in its progress toward sustainability. One way in which the sustainability engine 384 can make a quantitative estimate for a sustainability score is to count features 312 extracted from a geographical area by the features compiler 310. That is, the feature classes 326 into which features 312 are categorized each have an implication for community sustainability.

The sustainability engine 384 can also provide an information-rich and well-linked sustainability information center. In one implementation, the sustainability information center features an indicator checklist consisting of multiple questions designed to educate the user about means for achieving a more sustainable community.

The sustainability meters 390 indicate the neighborhood's progress toward sustainability. The sustainability meters 390 may dynamically show the results of an automated checklist, similar to the checklist introduced above for the sustainability information center, and be automatically updated so that the user can ascertain what impact a corrective action has on overall progress toward sustainability. In one implementation, the sustainability meters 390 have three color-coded indicator zones: for example, red means unsustainable, yellow means progressing towards sustainability, and green means sustainable.

The sustainability model 386 as well as the sustainability checklists derived from the sustainability model 386 may include a part or all of the following sustainability criteria, as sustainability factors:

1. Estimated carrying capacity of the natural resources—renewable and nonrenewable, local and nonlocal—that the community relies on.

2. Estimated carrying capacity of the ecosystem services upon which the community relies, whether local, global, or from specific distant sources.

3. Estimated carrying capacity of aesthetic qualities—the beauty and life-affirming qualities of nature—that are important to the community.

4. Estimated carrying capacity of the community's human capital—skills, abilities, health, and education of people in the community.

5. Estimated carrying capacity of a community's social capital—connections between people in a community: the relationships of friends, families, neighborhoods, social groups, businesses, governments, and their ability to cooperate, work together and interact in positive ways.

6. Estimated carrying capacity of a community's constructed capital—the human-made materials (buildings, parks, playgrounds, infrastructure, and information) that are needed for quality of life and the community's ability to maintain and enhance those materials with existing resources.

7. Estimated long-term view of the community.

8. Estimated economic, social, and biological diversity in the community.

9. Estimated equity and fairness—between current community residents (intra-generational equity) and between current and future residents (inter-generational equity).

10. Estimated strength of link between economy and environment.

11. Estimated strength of link between environment and society.

12. Estimated strength of link between society and economy.

13. Estimated sustainability that is at the expense of another community or at the expense of global sustainability.

An exemplary system 200 may include a neighborhood modeler to parse at least part of a postal zip code region into features, a sustainability modeler to assign the features into sustainability categories according to sustainability criteria, a sustainability estimator to determine a sustainability score for the categorized features, and a sustainability meter to display the sustainability score. The sustainability estimator may dynamically adjust the sustainability score based on a hypothetical change to one of the features, one of the relationships between features, or to one of the sustainability criteria.

Exemplary Methods

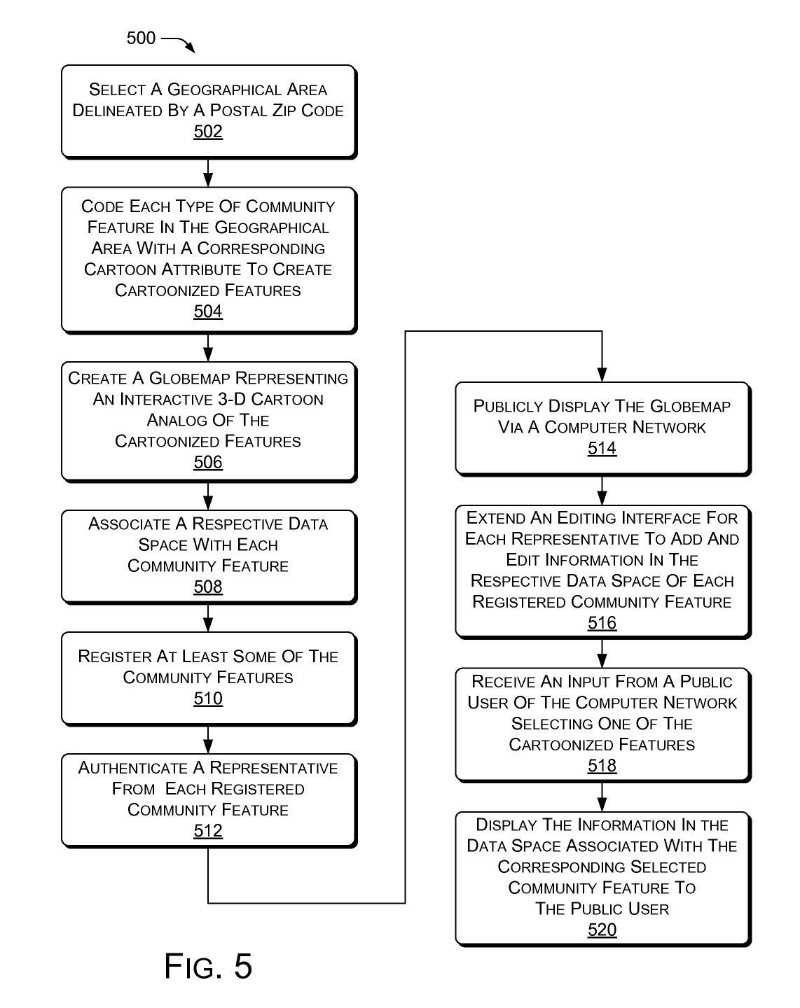

FIG. 5 shows an exemplary method 500 of creating an interactive analog of a neighborhood. In the flow diagram, the operations are summarized in individual blocks. The exemplary method 500 may be performed by hardware or combinations of hardware and software, for example, by the exemplary neighborhood modeling engine 104.

At block 502, a geographical area is selected, as delineated by a perimeter boundary, such as a postal zip code.

At block 504, each type of community feature in the geographical area is coded with a corresponding cartoon attribute to create cartoonized features.

At block 506, a globemap is created, representing an interactive 3-D cartoon analog of the cartoonized features.

At block 508, a respective data space is associated with each community feature.

At block 510, at least some of the community features are registered.

At block 512, a representative from each registered community feature is authenticated.

At block 514, the globemap is publicly displayed via a computer network.

At block 516, an editing interface for each representative for adding and editing information in the respective data space of each registered community feature is extended.

At block 518, an input from a public user of the computer network is received selecting one of the cartoonized features.

At block 520, the information in the data space associated with the corresponding selected community feature is displayed to the public user.

One implementation of the exemplary method 500 of creating an interactive analog of a neighborhood includes: selecting a geographical area delineated by a postal zip code, coding each type of feature within the geographical area with a corresponding cartoon attribute to create cartoonized features, creating a 2-dimensional (2-D) globemap of the geographical area, the 2-D globemap representing an interactive 3-dimensional (3-D) cartoon analog of the cartoonized features of the geographical area including visually rendering the interactive 3-D cartoon analog on at least part of the surface of a virtual sphere; associating an information data space with each cartoonized feature, authenticating a respective representative having a credential to represent a respective cartoonized feature, and receiving from the representative information and edits for customizing the information to be stored in the information data space associated with the cartoonized feature.

The implementation of the exemplary method 500 may further include displaying a part of the 2-D globemap including the associated cartoonized features, on a user interface, wherein the number of the cartoonized features included in the displayed part of the 2-D globemap varies to meet a visual simplicity threshold, and wherein the customized information associated with a cartoonized feature is individually accessible by navigating to the cartoonized feature on the user interface.

The features may include representations of geographical features, terrain, streets, infrastructure, toponyms, business entities, and community features of the geographical area, and the community features may include businesses, schools, churches, government organizations, parks, travel routes, physical structures, landscape features, and historical locations.

Visual distances between the cartoonized features may be distorted to create caricature of the neighborhood in the interactive 3-D cartoon analog. Actual distances between the features are stored for retrieval when a user navigates the 2-D globemap. The method 500 may include applying a fish-eye perspective to the interactive 3-D cartoon analog, wherein a greater degree of the fish-eye perspective is applied in relation to the size of the geographical area depicted, in order to accommodate displaying more of the geographical area around the edges of the virtual sphere.

For displaying, the method 500 may include receiving a first input from a user designating the postal zip code, displaying a part of the 2-D globemap including the associated cartoonized features rendered according to respective coded cartoon attributes on a user interface of the user; then receiving a second input from the user designating one of the cartoonized features and displaying the information from the information data space associated with the feature. The information associated with the feature may be displayed on a visual pane. The visual pane may display classified advertising information, business information, or community interest information associated with the respective individual feature.

The method 500 may further include extending navigation controls for a user to traverse the 2-D globemap of the geographical area via the user interface. The user-selection may select a smaller area within the geographical area than designated by the postal zip code, limiting creation of the 2-D globemap to the smaller area, i.e., designating the smaller area by drawing a shape around the desired smaller area.

When the user mouses-over one of the cartoonized features, the method 500 may display one or more of a location, a phone number, a web address, a business characteristic, a community sustainability characteristic, travel directions, and a directions icon related to the cartoonized feature, or a profile description, photo, video, sound, or data associated with the feature; directions to the feature, hours of operation, a schedule, community role, sustainability score, logo, link to a website of the feature, and a link to the information data space associated with the feature.

Navigation via the method 500 may include receiving a click-and-drag input from a mouse to move from a first part of the 2-D globemap to a second part of the 2-D globemap; receiving an identity of a street intersection and visually centering the street intersection in the center of the virtual sphere; receiving a click-and-drag input from a mouse for moving an icon along a street represented on the 2-D globemap of the geographical area, wherein moving the icon includes displaying the icon only along a representation of the street despite mouse input containing a movement vector directed away from the street; and displaying identity information of a street intersection when the icon arrives at a street intersection.

In one scenario the method 500 includes receiving navigation input to select a point on the 2-D globemap, receiving a mouse input indicating a movement of a mouse pointer over the 2-D globemap, dynamically displaying in real time an actual distance from the real geographical area between a first location in the geographical area corresponding to the point and a second location in the geographical area corresponding to the mouse pointer. Alternatively, the method 500 may include receiving navigation input from a mouse to select a first point and a second point on the 2-D globemap, and displaying driving directions between the first point and the second point. The first point can be established by inputting an address.

The method 500 may include receiving input from a user input device designating a route on the 2-D globemap, wherein the route is displayed as colored or highlighted on the user interface.

The method 500 may enable receiving navigation input for populating the 2-D globemap in stages, wherein populating the 2-D globemap in stages includes receiving input to execute a sequence of populating consisting of displaying one or more of a postal zip code boundary of the geographical area, a terrain of the geographical area, main streets of the geographical area, infrastructure of the geographical area, businesses of the geographical area, schools of the geographical area, parks of the geographical area, churches of the geographical area, etc., and each stage of the populating may be reversible.

In one implementation, displaying a part of the 2-D globemap includes displaying the globemap in a virtual sphere that has unvarying size dimensions. Creating the 2-D globemap representing the interactive 3-D cartoon analog may include generating a 3-D cartoon analog that is user-rotatable in multiple dimensions to provide multiple perspectives of each feature when presented on a 2-dimensional display to the user.

A user may designate one of the features, and the method 500 includes displaying a representation of an inside appearance of the feature when the feature comprises a building, a space, or a feature having an inside appearance.

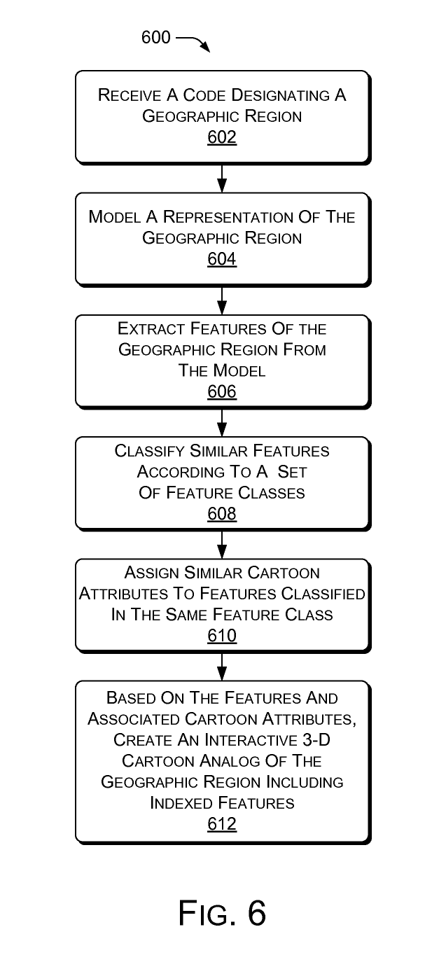

FIG. 6 shows an exemplary method 600 of coding and classifying features to create an interactive analog of a neighborhood. In the flow diagram, the operations are summarized in individual blocks. The exemplary method 600 may be performed by hardware or combinations of hardware and software, for example, by the exemplary neighborhood modeling engine 104.

At block 602, a code designating a geographic region is received.

At block 604, a representation of the geographic region is modeled.

At block 606, features of the geographic region are extracted.

At block 608, similar features are classified according to a set of feature classes.

At block 610, similar cartoon attributes are assigned to features classified in the same feature class.

At block 612, based on the features and associated cartoon attributes, an interactive 3-D cartoon analog of the geographic region including indexed features is created.

An implementation of the exemplary method 600 of coding and classifying features to create an interactive analog of a neighborhood may include color-coding similar features with corresponding colors or assigning a similar shape to corresponding features, and associating a common attribute to features of different types. Associating the common attribute indexes the features for searching or for classifying under the common attribute. The common attribute may include a personal attribute of a person associated with each of the community features, for example a senior citizen attribute, a handicapped attribute, an age group attribute, a membership attribute, or a lifestyle attribute.

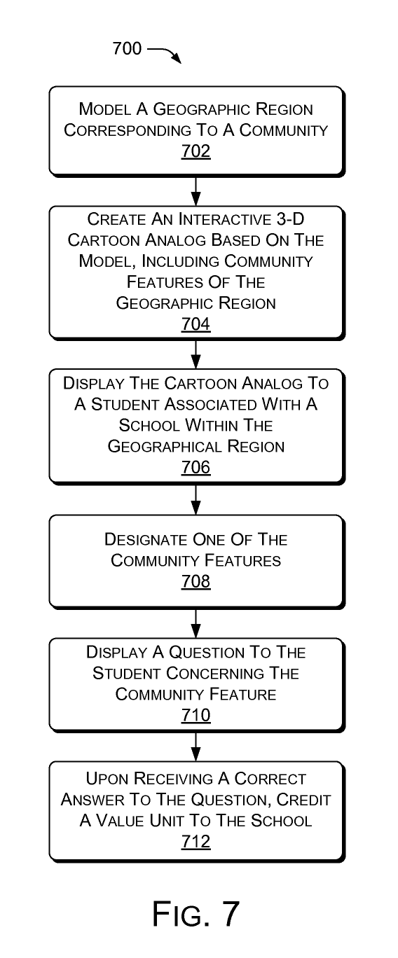

FIG. 7 shows an exemplary game method 700 for familiarizing a user with features of a neighborhood and offering a monetary reward for successful game play. In the flow diagram, the operations are summarized in individual blocks. The exemplary method 700 may be performed by hardware or combinations of hardware and software, for example, by the exemplary neighborhood modeling engine 104.

At block 702, a geographic region corresponding to a community is modeled.

At block 704, an interactive 3-D cartoon analog is created based on the model, including community features of the geographic region.

At block 706, the interactive 3-D cartoon analog is displayed to a student associated with a school within the geographical region.

At block 708, one of the community features is designated.

At block 710, a question is displayed to the student concerning the community feature.

At block 712, upon receiving a correct answer to the question, a value unit is credited to the school.

An implementation of the exemplary game method 700 may include modeling a geographic region, creating a cartoon analog from the model categorizing community features of the geographic region, associating a respective data space with each community feature, extending an editing interface via a computer network for each representative of one of the community features, the editing interface to add and edit information in the respective data space of the community feature, displaying the map to a student in a school within the geographic region, and upon receiving input from the student designating one of the community features, displaying a question to the student concerning the community feature or concerning the information stored in the data space associated with the community feature. Upon receiving a correct answer to the question from the student, the method 700 credits a value unit to the school.

The value unit may be an amount of money and the money may be revenue from an entity placing an advertisement displayed with the map to the student. A correct answer of a current question may draw a subsequent question of greater difficulty than the current question, but an incorrect answer of the current question may draw a subsequent question of lesser difficulty than the current question. In a scavenger hunt variation, the method 700 includes compiling a sample of the community features, requesting the student to locate on the analog a sequence of the community features in the sample, and when the student correctly locates a requested community feature, crediting the value unit to the school.

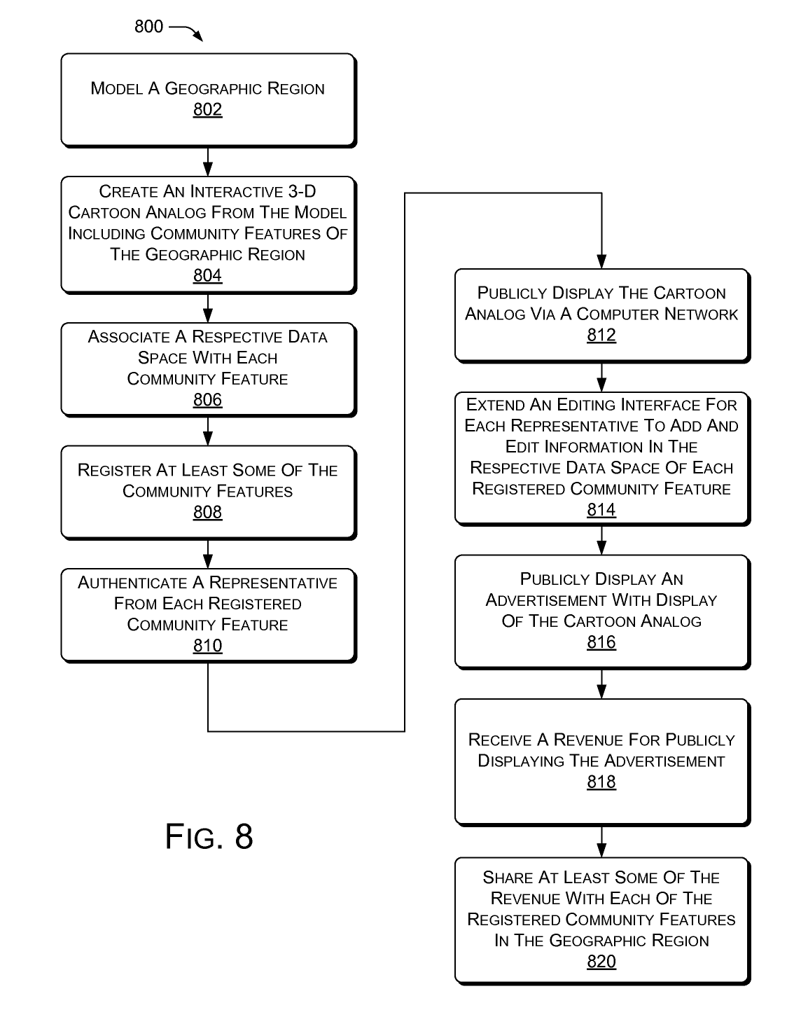

FIG. 8 shows an exemplary economic method 800 of collecting and distributing revenue associated with modeling a neighborhood. In the flow diagram, the operations are summarized in individual blocks. The exemplary method 800 may be performed by hardware or combinations of hardware and software, for example, by the exemplary neighborhood modeling engine 104.

At block 802, a geographic region is modeled.

At block 804, an interactive 3-D cartoon analog is created from the model including community features of the geographic region.

At block 806, a respective data space is associated with each community feature.

At block 808, at least some of the community features are registered.

At block 810, a representative from each registered community feature is authenticated.

At block 812, the cartoon analog is publicly displayed via a computer network.

At block 814, an editing interface is extended for each representative to add and edit information in the respective data space of each registered community feature.

At block 816, an advertisement is publicly displayed with the cartoon analog.

At block 818, a revenue is received for publicly displaying the advertisement.

At block 820, at least some of the revenue is shared with each of the registered community features in the geographic region.

One implementation of the exemplary economic method 800 of collecting and distributing revenue associated with modeling a neighborhood includes displaying an advertisement on part of the user interface, receiving a revenue for displaying the advertisement, and sharing at least part of the revenue with each representative who has added the information to the information data space of a respective feature.

Each information data space associated with a respective feature can be available to the associated representative free of charge. The method 800 may further include displaying classified advertisements submitted by the representatives of the features, and displaying each classified advertisement only to users who have sent the first user input designating the postal zip code. A sale of a good or a service can be transacted between a public user and the representative of one of the features via the information added by the representative of the feature. User accounts for public users can be created via a secure link provided among the information added by the representative of the feature.

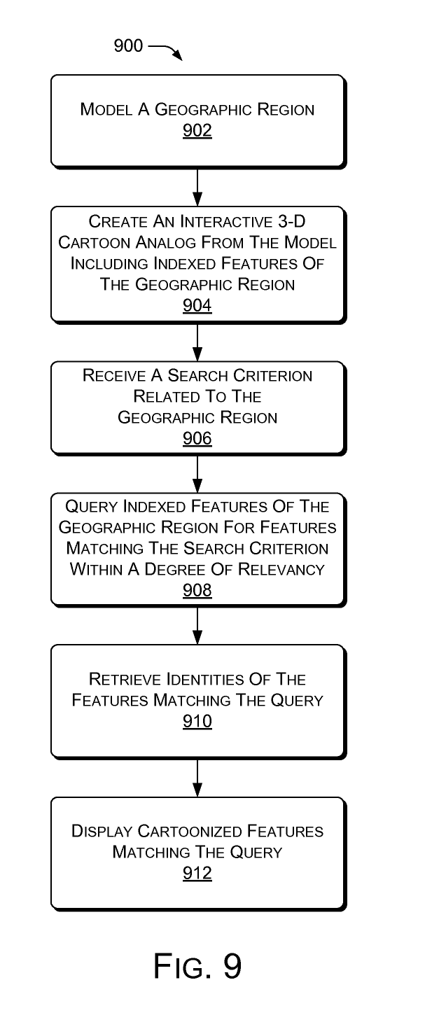

FIG. 9 shows an exemplary method 900 of searching for similar features within a modeled neighborhood. In the flow diagram, the operations are summarized in individual blocks. The exemplary method 900 may be performed by hardware or combinations of hardware and software, for example, by the exemplary neighborhood modeling engine 104.

At block 902, a geographic region is modeled.

At block 904, an interactive 3-D cartoon analog is created from the model including indexed features of the geographic region.

At block 906, a search criterion related to the geographic region is received.

At block 908, indexed features of the geographic region are queried for features matching the search criterion within a degree of relevancy.

At block 910, identities of the features matching the query are retrieved.

At block 912, cartoonized features matching the query are displayed.

An implementation of the exemplary method 900 of searching for similar features within a modeled neighborhood may include receiving a search criterion from a user designating one of the types of the features, finding the features that match the type criterion, and in the displayed part of the 2-D globemap, visually emphasizing each cartoonized feature of the designated type in response to the search criterion. A display of the interactive 3-D cartoon analog can be shifted within the 2-D globemap in order to display at least one instance of the designated type of feature in response to the search criterion. A search button may be displayed on the user interface, wherein when actuated, the search button executes the search according to an input search criterion that retrieves information about the features that match the search criterion. Alternatively, when actuated, the search button may initiate a search according to an input search criterion, wherein executing the search includes finding the features that match the search criterion, displaying the cartoonized features that match the search criterion, including applying the cartoon attribute that is common to the features and visually rendering the features as a group on the user interface according to the cartoon attribute.

### CONCLUSION

Although exemplary systems have been described in language specific to structural features and/or methodological acts, it is to be understood that the subject matter defined in the appended claims is not necessarily limited to the specific features or acts described. Rather, the specific features and acts are disclosed as exemplary forms of implementing the claimed systems, methods, and structures.

1. A system, comprising:
a computer network communicatively coupled with an Internet;
a server node in the computer network;
a neighborhood modeling engine associated with the server node to define a neighborhood and model an economy of the neighborhood;
a mapping engine associated with the neighborhood modeling engine to create an interactive analog of features in the neighborhood;
an authentication engine associated with the neighborhood modeling engine to register features in the neighborhood and to log in a representative of a registered feature to the neighborhood modeling engine;
a collaboration engine associated with the neighborhood modeling engine to enable each representative of a registered feature to add and edit information in a data space associated with a visual representation of the registered feature during a runtime of the interactive analog; and
an interaction engine to display at least some of the information in the data space associated with a visual representation of a feature when a user designates the feature via the Internet.

2. The system of claim 1, wherein the user actuates a search engine to designate the feature.

3. The system of claim 1, wherein the interactive analog comprises an interactive 3-D caricature of features in the neighborhood; and
wherein at least part of the interactive 3-D caricature is rendered on a 2-D display.

4. The system of claim 1, wherein the neighborhood modeling engine displays an advertisement; and
wherein revenue received from display of the advertisement is shared with each registered feature.

5. The system of claim 4, wherein the advertisement is associated with a function unrelated to the neighborhood modeling; and
wherein when the advertisement is selected a link activates the additional unrelated function.

6. The system of claim 5, wherein the additional unrelated function comprises a weather report.

7. The system of claim 1, wherein the data space comprises one of:
a shopping space for a registered feature to conduct sales transactions via the Internet;
an office space for the registered feature to conduct information exchanges related to operation of the registered feature; and
a gallery space for the registered feature to display merchandise and artworks.

8. The system of claim 1, further comprising:
a coding engine to categorize the features;
wherein when the interaction engine receives a search query for one of the features, the interaction engine searches categories of the categorized features to find a category matching the search query; and
wherein the neighborhood modeling engine displays the categorized features classified in the category matching the search query.

9. A system, comprising:
a neighborhood modeler to parse at least part of a postal zip code region into features;
a sustainability modeler to assign the features into sustainability categories according to sustainability criteria;
a sustainability estimator to determine a sustainability score for the categorized features; and
a sustainability meter to display the sustainability score.

10. The system as recited in claim 9, wherein the sustainability modeler assigns a relationship between two of the features into one of the sustainability categories.

11. The system as recited in claim 9, wherein the sustainability estimator dynamically adjusts the sustainability score based on a hypothetical change to one of the features, one of the relationships between features, or to one of the sustainability criteria.

12. A method, comprising:
modeling a geographic region;
creating a visual analog categorizing community features of the geographic region;
associating a respective data space with each community feature;
registering at least some of the community features into a database;
assigning a representative for each of at least some of the registered community features; and
during a runtime of publicly displaying the visual analog via a computer network, extending an editing interface via the computer network for each representative to add and edit information in the respective data space of each registered community feature while publicly displaying the visual analog via the computer network.

13. The method of claim 12, further comprising:
receiving an input from a public user of the computer network selecting one of the community features; and
displaying the information in the data space for the selected community feature to the public user.

14. The method of claim 12, further comprising:
publicly displaying an advertisement via the computer network;
receiving a revenue for publicly displaying the advertisement; and
sharing the revenue with each of the registered community features in the database.

15. The method of claim 12, further comprising receiving a search query for one of the community features;
searching categories of the categorized community features to find a category matching the search query; and
displaying the categorized community features classified in the category matching the search query.

16. The method of claim 12, wherein various services are performed free of a monetary charge for each registered community feature while sharing the revenue with each of the registered community features;
wherein associating the respective data space with each community feature is performed free of a monetary charge for each registered community feature;
wherein registering the at least some of the community features into a database is performed free of a monetary charge for each registered community feature;
wherein assigning the respective representative for each registered community feature is performed free of a monetary charge for each registered community feature; and
wherein extending an editing interface via the computer network for each representative to add and edit information in the respective data space of each registered community feature is performed free of a monetary charge for each registered community feature.

17. The method of claim 12, further comprising receiving a user-drawn shape designating the geographical region.

18. The method of claim 12, further comprising displaying one of a profile description of the feature, a photo of the feature, a video of the feature, a sound associated with the feature, a data associated with the feature, directions to the feature, hours of operation of the feature, a schedule associated with the feature, a community role of the feature, a sustainability attribute of the feature, a logo of the feature, or a link to a website of the feature.

19. The method of claim 12, further comprising populating the visual analog with community features in stages based on receiving input from a user input device.

20. The method of claim 19, wherein populating the visual analog in stages includes receiving input to execute a sequence of populating consisting of displaying one or more of a postal zip code boundary of the geographical area, a terrain of the geographical area, main streets of the geographical area, infrastructure of the geographical area, businesses of the geographical area, schools of the geographical area, parks of the geographical area, and churches of the geographical area; and
wherein each stage of the populating is reversible.
